(19) United States
(12) Patent Application Publication
(10) Pub. No.: US 2020/0024295 A1
(43) Pub. Date: Jan. 23, 2020

(54) NANOPARTICLES AND PREPARATION METHOD

(71) Applicant: JOHNSON MATTHEY PUBLIC LIMITED COMPANY, London (GB)

(72) Inventors: NICOLETA MURESAN, Reading (GB); DAVID THOMPSETT, Reading (GB)

(21) Appl. No.: 16/516,592

(22) Filed: Jul. 19, 2019

(30) Foreign Application Priority Data
Jul. 20, 2018 (GB) 1811892.7

(51) Int. Cl. C07F 15/00; B01J 35/00; B01J 31/18; B01J 37/02; B01J 37/08; C07F 15/04; B01J 20/22

(52) U.S. Cl. CPC C07F 15/0066; B01J 35/0013; C07F 15/0093; B01J 31/181; B82Y 30/00; B01J 37/0209; B01J 37/08; C07F 15/045; B01J 20/223; B01J 35/006

(57) ABSTRACT

The present invention concerns a composite comprising supported nanoclusters, the nanoclusters comprising one or more metal ion-containing compounds, wherein each metal ion-containing compound is a transition metal complex having ligands coordinated to a transition metal ion, the ligands being selected from the group consisting of glyoxime; a glyoxime derivative; salicylaldimine; and a salicylaldimine derivative; and wherein the nanoclusters are spaced across one or more surfaces of a support; a material prepared from the composite by annealing; and solution-based methods for forming the composite and materials. Uses of the metal ion-containing compounds are also described, as are uses of the products as catalysts and adsorbers.

### FIELD OF THE INVENTION

The present invention relates to a method of preparing metal nanoparticles. In particular, but not exclusively, the present invention relates to nanoparticles, especially supported nanoparticles, and composites prepared during their formation. The nanoparticles are suitable for use as materials that are active towards gases, such as catalytic or adsorbing materials. The present invention also relates to materials comprising the nanoparticles.

### BACKGROUND

Catalysts are almost ubiquitous: they are used in an ever-increasing range of methods and for a huge variety of applications. Thus, there is a general and continuous drive to find new and improved catalysts, and methods of making them.

Many catalysts and other active materials are used in conjunction with gas-phase reactants, though the active materials themselves are commonly solid. One set of applications in which active materials are particularly desirable is in the treatment of exhaust gases from fuel engines. Current fuel engines such as diesel engines apparently unavoidably generate several undesirable gases as by-products of the combustion process. Presently, active materials are used for a variety of applications including for diesel and compressed natural gas (CNG) oxidation, lean and stoichiometric NOx reduction, gasoline three-way catalysis, methane oxidation (MeOx), ammonia oxidation, and in passive NOₓ adsorbers (PNAs). Thus, an exhaust gas system for an engine may have several different materials present e.g. as part of individual devices tailored to specific functions.

At their most general, materials for use in such applications including MeOx and PNAs often comprise transition metal nanoparticles distributed across a support material. The transition metal nanoparticles that are used vary in composition according to application. Commonly, they are nanoparticles based on single metals, intimate mixtures of metals, alloys, or oxides of any of the single metals, intimate mixtures, or alloys.

Usually, it is preferable if the nanoparticles are homogeneous in size and have a good, uniform distribution across the support surface to maximise efficiency. In some instances, it is desirable to control the location of deposition of the transition metal nanoparticles. It is also desirable to have small particles, to maximise the available surface area for catalysis of the appropriate reaction or adsorption. Thus, in general, it is desirable to be able to control the size, location and/or distribution of the nanoparticles across a support surface.

Another challenge particularly for materials used in the treatment of exhaust gases relates to the fact that the temperatures of the exhaust gases are relatively low (e.g. about 400° C. for e.g. diesel engines). It is therefore desirable to develop catalysts and PNAs and other active materials that have good function at these temperatures, and which are durable.

The activity of oxidation catalysts is often measured in terms of its “light-off” temperature. This is the temperature at which the catalyst starts to function, or at which the catalyst functions at a certain level. It may be given in terms of a reactant conversion level. Different catalysts generally have different “light-off” temperatures, but as noted, for an exhaust gas system a useful upper limit is generally quite low. The performance of such catalysts is important e.g. because it affects the performance of any downstream emissions control devices.

Another challenge relates to the formation of nanoparticles comprising multiple metallic elements (multiple kinds of metal). In general, it is desirable to have small particles to maximise the available active surface area. Formation of metal alloys, for example, often requires heating at high temperature to sufficiently intermix the different kinds of metal atoms. Unless widely spaced, individual nanoparticles can often agglomerate during such heating step. Thus, metal alloy particles can grow to a size that leads to lower efficiency.

Preferred embodiments of the present invention seek to overcome one or more of the above disadvantages of the prior art. In particular, preferred embodiments, the present invention seeks to provide improved metal nanoparticles and metal nanoparticle-containing composites and materials for use as active materials, particularly suitable for applications such as MeOx and PNAs, as well as an improved and diverse method for producing the metal nanoparticles.

### SUMMARY OF THE INVENTION

According to a first aspect of the invention, there is provided comprising supported nanoclusters, the nanoclusters comprising one or more metal ion-containing compounds, wherein each metal ion-containing compound is a transition metal complex having ligands coordinated to a transition metal ion, the ligands being selected from the group consisting of glyoxime; a glyoxime derivative; salicylaldimine; and a salicylaldimine derivative; and wherein the nanoclusters are spaced across one or more surfaces of a support.

According to a second aspect of the invention, there is provided a material formed from the composite of the first aspect, in which the composite is subjected to a heating step to form metal-containing nanoparticles from the nanoclusters.

According to a third aspect of the invention, there is provided a catalyst or passive NOₓ adsorber comprising the material of the second aspect.

According to a fourth aspect of the invention, there is provided a method of forming supported metal-containing nanoparticles or oxide thereof, the method comprising:
a. providing one or more transition metal ions by providing one or more metal ion-containing compounds and a support;
b. dissolving the one or more metal ion-containing compounds in a solvent;
c. a step of combining the support with the dissolved one or more metal ion-containing compounds;
d. a heating step in which the one or more metal ion-containing compounds are subjected to a temperature of at least 300° C. to form metal-containing nanoparticles or oxide thereof on the support;
e. a cooling step comprising cooling the product of step d; and optionally
f. a step of acid leaching;

wherein the one or more metal ion-containing compounds are transition metal complexes having ligands coordinated to a transition metal ion, the ligands being selected from the group consisting of glyoxime; a glyoxime derivative; salicylaldimine; and a salicylaldimine derivative.

The method of the fourth aspect comprises providing a support such that the nanoparticles comprising one or more metals, or oxide thereof, are formed on the support. Such supported nanoparticles are advantageous in terms of processing and downstream applications. Further preferably, the heating step of these aspects is carried out in an oxidising atmosphere. The methods herein permit comparatively temperatures to be used during manufacture, such as between 300 and 600° C., which is advantageous from an environmental and manufacturing perspective. An oxidising atmosphere also substantially avoids or minimizes formation of a coating on the nanoparticle surface during manufacture, which may be desirable for certain applications described herein.

Preferably, the method results in a material according to the second aspect.

According to further aspects of the invention, there is provided a use of at least two metal ion-containing compounds which are selected from the group consisting of metal glyoximes, metal glyoxime derivatives, metal salicylaldimines, and metal salicylaldimine derivatives, in a method of forming metal nanoparticles or oxide thereof, the metal nanoparticles comprising at least two transition metals; a use of a metal ion-containing compound which is a metal glyoxime, a metal glyoxime derivative, a metal salicylaldimine or a metal salicylaldimine derivative, in a method of forming metal-containing nanoparticles or oxide thereof, the method comprising dissolving the metal ion-containing compound in a solvent; optionally to form a composite of the first aspect or a material of the second aspect, or wherein the method is a method according to the third aspect; and use of the metal-containing nanoparticles or oxide thereof as a catalyst or in a passive NOx adsorber.

It will be appreciated that features described in relation to one aspect of the invention may be equally applicable in another aspect of the invention. For example, features described in relation to the first aspect of the invention, may be equally applicable to the second, third and/or further aspects of the invention, and vice versa. Some features may not be applicable to, and may be excluded from, specific aspects of the invention but this will be clear from the context.

### DESCRIPTION OF THE DRAWINGS

Embodiments of the present invention will now be described, by way of example, and not in any limitative sense, with reference to the accompanying drawings, of which:

FIG. 1 is a schematic representation of supported metal alloy nanoparticles prepared according to the methods of the present invention.

FIG. 2A is a schematic representation showing the theoretical result of combining two kinds of metal glyoximes, with the different first and second metal centres represented by M¹ and M², respectively. Each M independently represents a metal as defined herein; each R independently represents H or a derivative group as described herein. The relative sequence of M¹ and M² and orientation of ligands is for illustrative purposes. The present invention is not limited to this orientation or sequence, but instead encompasses any orientation or sequence within the limits described herein.

FIG. 2B is a schematic representation showing the theoretical result of combining three kinds of metal glyoximes, with the mutually different first, second and third metal centres represented by M¹, M² and M³, respectively. Each M and R has the same definition as for FIG. 2A. The relative sequence of M¹, M² and M³ and orientation of ligands is for illustrative purposes. The present invention is not limited to this orientation or sequence, but instead encompasses any orientation or sequence within the limits described herein.

FIG. 3A is a transmission electron microscope (TEM) image of Pd and Pt-containing nanoparticles prepared by a deposition precipitation method according to Example 1. The scale bar in FIG. 3A is 20 nm.

FIG. 3B shows particle size distribution of Pd and Pt-containing nanoparticles prepared by a deposition precipitation method according to Example 1. FIG. 3B shows mean particle size=4.7 nm; σ=1.3 nm.

FIG. 4A is a TEM image of Pd and Pt-containing nanoparticles prepared by a deposition precipitation method according to Example 4 before firing. The scale bar is 30 nm.

FIG. 4B is a TEM image of Pd and Pt-containing nanoparticles prepared by a deposition precipitation method according to Example 4 after firing at 500° C. in air. The scale bar is 30 nm.

FIGS. 5A and 5B concern PtPd nanoparticles prepared by a deposition precipitation method according to example 5. FIG. 5A shows a TEM image of a sample prepared by annealing at 500° C. in air, and represents a “fresh” sample; FIG. 5B shows a TEM image of the sample following exposure to 700° C. for 40 hours after the original annealing process, and represents an “aged” sample. Scale bar for FIG. 5A is 50 nm; scale bar for FIG. 5B is 100 nm.

FIGS. 6A and 6B show results of methane oxidation testing using 3Pd/ZSM-5 (i.e. Pd on a ZSM-5 zeolite framework support) prepared by deposition precipitation methods as described herein. FIG. 6A represents the water tolerance in the absence of SO₂; and FIG. 6B represents the effect of SO₂ on the activity. In each, the solid grey line (predominantly lower than the black line) represents methane conversion by a sample prepared using PdN; the solid black line (predominantly above the grey line) represents the sample according to the invention. The dashed line represents the temperature; the peak temperature is 550° C. and is 400° C. at the end of the test. In FIG. 6A, the water content in the feed is about 10%. In FIG. 6B, the samples were exposed to 2 ppm SO₂ for 100 mins, and SO₂ was turned off for the remaining 80 mins. The temperature was increased again to 550° C. before being reduced to 440° C. during the time that the SO₂ was turned off.

FIGS. 7A, 7B, 7C, and 7D compare the particle sizes and dispersion of 3Pd on zeolite prepared using (7A and 7B) deposition precipitation process using Pd-DMG₂ as metal ion-containing component and (7C and 7D) a corresponding process using Pd-nitrate. FIGS. 7A and 7C are representative high-resolution TEM images, each with a scale bar of 50 nm.

FIGS. 7B and 7D show the corresponding particle size distributions i.e. the size distribution in FIG. 7B corresponds with the sample in FIG. 7A (mean size=7.2 nm; 6=3.6) and the size distribution in FIG. 7D corresponds with the sample in FIG. 7C (mean size=12.6; 6=6.9).

FIGS. 8A and 8B show TEM images of 3% Pd on a zeolite (having a different silica to alumina ratio (SAR) to that used in the FIGS. 7A, 7B, 7C, and 7D sample) prepared by deposition precipitation using Pd-DMG₂. FIG. 8A shows the particles before annealing (approximately 2 nm size); and FIG. 8B shows the particles after annealing at 500° C. for 2 hours (size approximately 5-7 nm). The scale bars are 20 nm in FIG. 8 A, and 50 nm in FIG. 8B.

FIG. 9 shows NOₓ storage performances of Example 10 and Comparative Example 6.

### DETAILED DESCRIPTION

The present invention has several advantages, including but not limited to:
it provides a material having metal-containing nanoparticles of controllable size and composition, and which have a relatively high homogeneity and distribution across the support, leading in turn to improved properties;
it provides a single-vessel process or one-pot method for preparing single metal nanoparticles, metal alloy nanoparticles, nanoparticles comprising an intimate mixture of metals or oxides thereof, of a size, homogeneity and distribution across a support useful for various catalytic and related applications;
the method avoids significant growth of nanoparticles, particularly metal alloy nanoparticles; and
there is increased interaction between metal and support, where present, which the inventors believe leads to more stable supported metal-containing nanoparticles suitable for use as active materials such as catalysts and adsorbers.

At a general level, the present invention provides metal nanoparticles, particularly supported metal nanoparticles and particularly supported transition metal nanoparticles. There is believed to be a wide range of kinds of nanoparticles that can be provided according to the invention. The adaptability of the present invention is expected to have potential to apply the present disclosure to a range of kinds of support, and to a range of catalyst and related materials e.g. adsorbers.

For example, the present invention provides single-metal nanoparticles and multi-metal nanoparticles, as well as oxides of each of the single- and multi-metal nanoparticles. The general terms ‘metal nanoparticles’ or ‘metal-containing nanoparticles’ are used herein to encompass each of these options. The term ‘multi-metal nanoparticles’ encompasses nanoparticles comprising intimate mixtures of metals as well as metal alloy nanoparticles, and is not particularly limited by number of different kinds of metals (though two is generally most common). References to ‘oxide thereof’ means an oxide of the metal, and refers to each type of single- or multi-metal containing component listed.

### Definitions and Explanations

As used herein, the expression “C_{x-y}” where x and y are integers takes the standard meaning i.e. it means having between x and y carbon atoms in the chain.

The term “square planar” is well known in the art. In general, it refers to a coordination compound or complex having coordinating ligand atoms positioned at approximately the corners of a square around the transition metal ion centre. The skilled person recognises that some deviation from precise planarity and precise square shape is encompassed within the meaning of square planar as it is used in the art and herein.

The prefix “nano” is commonly used in the art to describe dimensions measured on the nanometre scale. In the context of the present description, “nano” means a dimension of between 0.5 and 100 nm. This can include references to prior art or comparative dimensions; specific definitions e.g. for size ranges as applicable to the products of the present invention are set out elsewhere.

As used herein, the term “passivation” has the meaning understood by the skilled person i.e. a treatment that causes a metal surface to become inert (non-reactive). As is known, this usually occurs by forming a film or coating of metal oxide on the surface of the metal.

The term “acid leaching” herein has the meaning understood by the skilled person i.e. treatment of metal with acid to extract acid-soluble components.

The term “nanocluster” is used to describe an agglomeration or accumulation of molecules having a nano-size as defined elsewhere herein. The term encompasses, but is not necessarily limited to, randomly aligned or ordered arrangements of molecules, such as stacks or chains. No shape limitation is intended.

Zeolites and zeotypes—sometimes known as molecular sieves—are crystalline microporous solids with ordered micropore structures. They are defined not only by their composition, but also the arrangement of the tetrahedral atoms that bound the cavities, channels and/or pores that make up the structure. A full listing of framework types is maintained by the IZA

(International Zeolite Association) at http://www.iza-structure.org/data-bases/ and each is given a unique 3-letter code. Zeolites were traditionally considered to be crystalline or quasi-crystalline aluminosilicates constructed of repeating TO₄ tetrahedral units with T usually being Al and Si (although other atoms such as B, Fe and Ga have been described). For aluminophosphates, T is Al and P. Zeolites are often doped with other ions to induce ion-exchange properties, or with charge equivalent ions to give different types of sites.

By the term “zeolite-based” we mean doped zeolites. By way of non-limiting example, zeolites may be doped with one or more elements such as Cu, P or Na. “Zeolite” as used herein encompasses “zeolite-based” unless specifically indicated otherwise.

The term “NOx” in the context of the present invention is well-understood by the skilled person. It refers to oxides of nitrogen. Especially, it concerns oxides of nitrogen which are produced by a combustion engine and expelled as exhaust gas.

The term “intimate mixtures” means a mixture that is pseudo-homogenous on a nano-scale.

As used herein, the term alloy has the normal meaning understood by a person skilled in the art and encompasses materials having metal-metal bonds between at alloying elements.

Diesel oxidation as described in the background section is a term of art which encompasses oxidation of CO, hydrocarbons and NO in fuels. Similarly, gas three-way oxidation is a well-established term of art, encompassing substantially coincident oxidation of CO and hydrocarbons, and NOx reduction.

By “slurry”, we mean a liquid comprising insoluble matter e.g. insoluble particles.

Where the present specification refers to “a” or “an”, this encompasses the singular and plural forms.

Products

The metal-containing nanoparticles according to the present invention are nanoparticles comprising single metals, multiple metals, or oxides of each of these. The metals are transition metals.

Where the metals comprise more than one metal, the metal nanoparticles comprise at least two metals, particularly at least two transition metals. Transition metals are elements of Group 3 to 12 of the periodic table. The different metal elements are sometimes referred to herein as different kinds of metals. Preferred transition metals are set out elsewhere herein.

The at least two transition metals may optionally be alloyed together. Preferably, alloy nanoparticles are bimetallic alloy nanoparticles, but they may alternatively be trimetallic or higher alloy nanoparticles. Alternatively, the at least two transition metals may not be alloyed together in the metallurgical sense, but may instead be a mixture of the metals.

It will be appreciated that use of inert atmospheres is less likely to produce oxides of the various metal-containing nanoparticles described herein. In oxidising atmospheres, at least some oxidation e.g. partial oxidation may occur e.g. at the nanoparticle surface, or oxidisation may occur throughout the nanoparticles. Oxides as used herein can encompass mixed oxides, as well as a mixture of oxides. The skilled person is aware that certain metals e.g. Pt and Au, are generally difficult to oxidise, and in such cases other oxidation methods known to the skilled person may be needed to achieve metal oxides if desired.

A nanoparticle of the invention is typically a fine particle of one or more metals. It typically has a size of less than 50 nm, and more typically less than 20 nm. Preferably, the nanoparticles of the invention have a mean size of around 15 nm or less. The lower size limit of the nanoparticles is not particularly limited, but they may be as small as e.g. 0.5 nm, and typically at least 1 nm. The range of mean sizes of the alloy nanoparticles produced herein are typically between 1 and 50 nm. Particularly preferred for the presently described applications are mean particle sizes of up to 10 nm, up to 9 nm or up to 8 nm. Particularly contemplated is a mean size between 2 and 7 nm, such as for example 3 nm or 4 nm.

The size of the particle refers to the width of the particle, which is the diameter for spherical or spheroidal particles. Methods of measuring particle sizes are known to the skilled person, and may include for example analysis of TEM images.

The metal-containing nanoparticles produced are typically spheroidal in shape though the present invention is not limited by the shape. The metal nanoparticles may be of any convenient shape, including but not limited to oval, needle-like and spherical (spheroidal).

Where the metal-containing nanoparticles comprise more than one metal, suitable proportions of each metal can be chosen by the skilled person according to requirements. The amounts of each metal in the nanoparticles is not particularly limited. By way of example, metal:metal weight ratios can be between around 99:1 to 1:99, such as between 80:1 to 1:80 or 60:1 to 1:60. In some embodiments, especially but not exclusively in particularly preferred embodiments using Pd and Pt the metal:metal weight ratio can be between around 25:1 to 1:25, such as 10:1 to 1:10, or 3:1 to 1:3, including 1:1.

The metal-containing nanoparticles may be used in the form in which they are produced at the end of the cooling step, or after the optional leaching step if appropriate. Alternatively, the metal-containing nanoparticles may be further processed before use. Exemplary further steps are discussed elsewhere herein.

Without wishing to be bound by theory, the inventors believe that certain methods of metal nanoparticle preparation, particularly in an inert annealing atmosphere, result in nanoparticles having a coating (also called an “overlayer” herein), which typically extends substantially continuously over the product. X-ray photoelectron spectroscopy (XPS) data has been used to indirectly infer its presence. Specifically, the XPS data indicates that the coating comprises nitrogen, oxygen and carbon. It is believed that this coating, formed in particular during the manufacture of metal alloy nanoparticles under inert conditions, assists in preventing the agglomeration or sintering of the nanoparticles. Agglomeration and sintering is usually found to be particularly problematic during heating processes required for the formation of metal alloys.

This result is unexpected. US 2010/152041A1 discloses a method of preparing single-metal nanoparticles comprising heating a powder comprising a chelate complex of two dimethyl glyoxime molecules and one transition metal, optionally in the presence of alumina, at 300-400° C. to form nanoparticles of Ni. The methods of preparation described in this application involve the direct heating of the Ni-DMG powder in air, or the milling of Ni-DMG powder with alumina whiskers and subsequent heating. This document reports that Ni nanoparticles formed on carbon particles in the absence of alumina, while in the presence of alumina the Ni nanoparticles are carried on alumina. It also describes that at temperatures above 400° C., substantial sintering and/or agglomeration is observed i.e. substantially larger particles result. Thus, the present invention is more adaptable than previously known methods, at least because higher temperatures can be used with minimal sintering and/or agglomeration. There is no suggestion that a coating can be formed. It could not be predicted that a solution-based preparation of metal nanoparticles as described herein could also lead to excellent results.

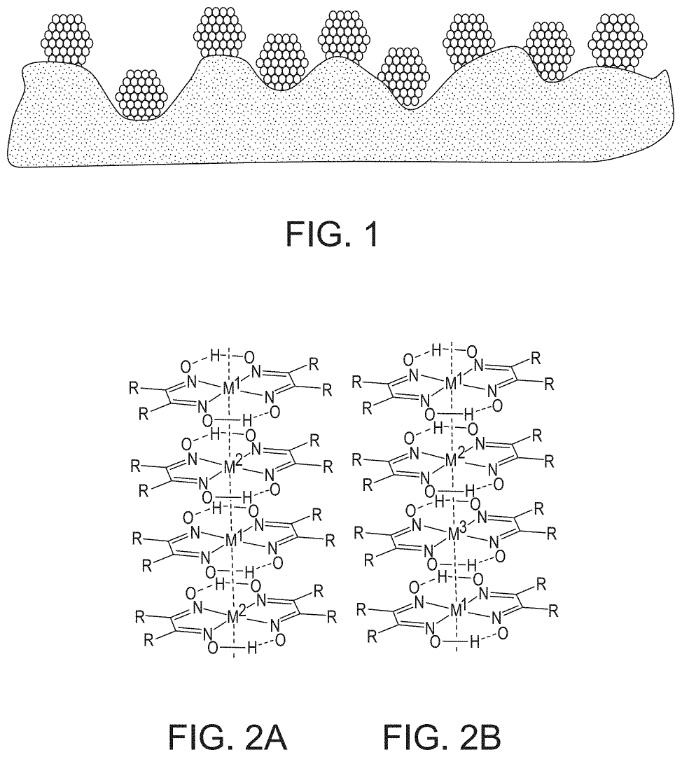

FIG. 1 is a schematic representation of a product prepared according to the present methods. In FIG. 1, a support is shown in black at the bottom of the drawing. This can be any suitable support as described herein. In FIG. 1, the support is shown as having a flat lower surface and an irregular upper surface, but this is not limiting in the invention.

The grey hexagons represent metal-containing nanoparticles. The hexagonal shape is not limiting. Additionally, although the hexagons are shown in FIG. 1 as being identical in size, this is of course also not necessarily representative of all products prepared according to the present methods i.e. they may be of different sizes to one another. The metal-containing nanoparticles in FIG. 1 are divided into spheres, which represent multiple metal elements. Like the hexagonal shape, it is not intended that the spherical shapes are representative of the individual domains of metal within the nanoparticles because of course they could take a variety of shapes and sizes. It should be noted that the individual spheres can represent any suitable number and kind of metals, and any suitable bonding e.g. alloyed particles.

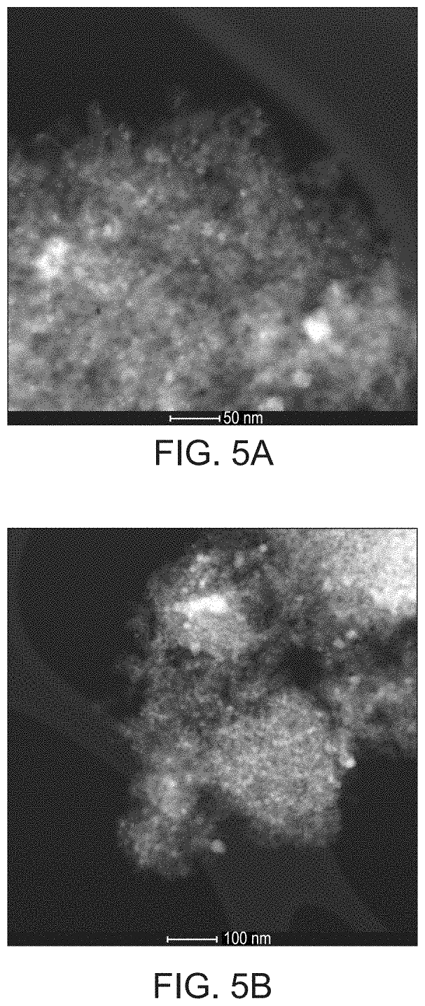

A composite of the present invention in general comprises a support material and a nanocluster of molecules which are metal ion-containing compounds as defined elsewhere. In practice, the support will comprise a plurality of nanoclusters. The nanoclusters are generally dispersed or distributed across one or more surfaces of the support. That is, they are spaced (i.e. arranged with nanocluster-free areas separating them) such that individual nanoclusters can be identified. It has been found that the nanoclusters show a good distribution across the support; that is, they do not clump together or aggregate. See for example FIG. 4a. In FIG. 4a, small spheroidal areas of light grey can be seen, separated by regions of darker grey or black. The light grey areas are nanoclusters, and especially metal ions of the clustered metal ion-containing compounds. The nanoclusters of this example can be seen to be relatively homogeneous in size, well separated from one another and have a good distribution across the support. Similar properties can be seen for the light grey nanoparticles formed from these nanoclusters, see e.g. FIG. 4b, in which the very light, spheroidal areas are the nanoparticles, and are also separated by regions of less light grey.

Depending on the kind of support used, it may be possible to control the location and/or distribution of the nanoclusters. For example, materials having ion-exchange sites are suitable for controlling the location and/or distribution of the nanoclusters of the composite and may be used in the methods of the invention.

Without wishing to be bound by theory, it is believed that the nanoclusters comprise stacks of metal ion-containing compounds, having aligned chains of metal ions. This ability to form stacks is thought to lead to a close metal-metal interaction, intimate mixing (stacking) of the metal ions, and with fast precipitation during the preparation process. Accordingly, diffusion distances are small and thus little movement is needed by the metal ions on heating to form metal-containing nanoparticles, especially metal alloy-containing nanoparticles.

The composite of the invention is an intermediate formed during the methods of the present invention, following deposition and precipitation of the metal ion-containing compounds on the support, but before the heating step which acts to separate, partially separate, decompose or substantially decompose the ligands from the metal ion of the metal ion-containing compounds. Although an intermediate, the composite can be isolated and assessed. The composite can be annealed/heated/fired to provide transition metal-containing nanoparticles. [The heating step is sometimes referred to as annealing or firing herein.] That is, the ligands of the metal ion-containing compounds (complexes) are partially, substantially or completely removed or separated from the metal ion and the metal ions themselves form metal-metal bonds. In some instances, complete removal and optionally decomposition of the ligands is contemplated. The resulting material, sometimes called an “active” material, may find utility in catalytic or related applications. It is noted that the composite containing the nanoclusters may also be active e.g. as a catalyst or adsorbing material; this possibility is not intended to be excluded.

The nanoclusters may show a slightly smaller size than the final nanoparticles—as seen by comparing e.g. FIGS. 4a and 4b—or they may be substantially similar in size or even larger (nanoclusters may e.g. shrink during the firing step as the ligands are decomposed). Nanoparticle and nanocluster size may be measured by TEM or XRD according to known and standard methods and protocols. For example, a TEM image may be taken and appropriate software used to determine nanoparticle or nanocluster size. Alternatively, TEM images may be printed and the measurement made by hand.

Thus, the nanoclusters may have a mean size which is less than 50 nm, typically less than 30 nm and less than 15 nm. The nanoclusters may have a mean size which is more than 0.5 nm, typically more than 1 nm and in some instances more than 1.5 nm. Preferably, the mean size range of the nanoclusters is between around 0.5 nm and 10 nm, typically between 1 nm and 7 nm and preferably between 1.5 nm and 5 nm, such as 2 nm or 3 nm.

The metal-containing nanoparticles may be used as part of a catalytic material, particularly as part of a catalyst for oxidation reactions such as MeOx. The metal-containing nanoparticles may alternatively be used as part of a different kind of active, such as an adsorbing material for use in e.g. a PNA.

For such applications, supported nanoparticles as prepared by the methods described herein can be provided as powders. These powders may typically be coated onto structures such as ceramic or metallic honeycombs. The nanoparticle-containing powders may optionally be dispersed in water, for example to prepare an aqueous slurry, to provide a form suitable for coating. The slurry or dispersion can be formulated with organic and/or inorganic additives according to necessity or preference for compatibility with the specific coating method intended.

In some alternative examples, nanocluster deposition could take place within the coating slurry by adding a solubilized solution of the metal-containing compound(s) to the dispersed support, and adjusting the pH to ensure deposition of nanoclusters on the support as described elsewhere herein. The resulting metallized slurry may then formulated for coating by the addition of the additives mentioned above and then coated onto appropriate structures. Generally, the coating is then annealed to stabilize the coating for adhesion and cohesion and in this case the nanoclusters decompose to form the metal-containing nanoparticles.

Catalytic and other active materials of the present invention are prepared from the composite materials described herein. In general, the active materials are prepared by converting the nanoclusters of metal ion-containing compounds into metal-containing nanoparticles. This is typically achieved by annealing as explained above. The annealing process is believed to decompose the metal ion-containing compounds, thereby removing, or substantially removing, the ligands of the metal ion-containing compounds. This in turn allows the metal ions to bond and metal-containing nanoparticles to form from the nanoclusters.

Thus, if the nanoclusters contain metal ion-containing compounds having one kind of metal ion, the annealing process provides a catalytic material having single-metal nanoparticles. If the nanoclusters contain more than one kind of metal ion in the metal ion-containing compounds, the annealing process provides a catalytic material having multi-metal nanoparticles.

Use of oxidising conditions during the annealing process may promote oxidation of the metal(s) present in the nanocluster and form metal oxide-containing nanoparticles. This in turn is believed to cause the formation of metal oxide-containing nanoparticles. For example, the use of air in the annealing process can result in metal oxide-containing nanoparticles. It is preferred to anneal the composite under oxidising conditions, most preferably under air. The skilled person understands that in some examples, where the metal is more stable e.g. Pt or Au, oxidation may be more difficult, particularly at higher temperatures, and so the metal, and not its oxide, may result from use of an oxidising atmosphere.

Further details of preferred annealing conditions are set out below, described under the heading “heating step”.

The loading of the metal on the support will be determined by the skilled person according to the application desired. However, in general it is expected that a metal loading of up to 10 wt %, such as around 9.5 wt % or less will be of interest. Suitable metal loadings are at least 0.5 wt % such as 1 wt % or more. Suitable ranges of metal loadings may be between 1-7 wt %, preferably between 2-6 wt %. Metal loadings that are too high may lead to an unacceptably large metal particle size.

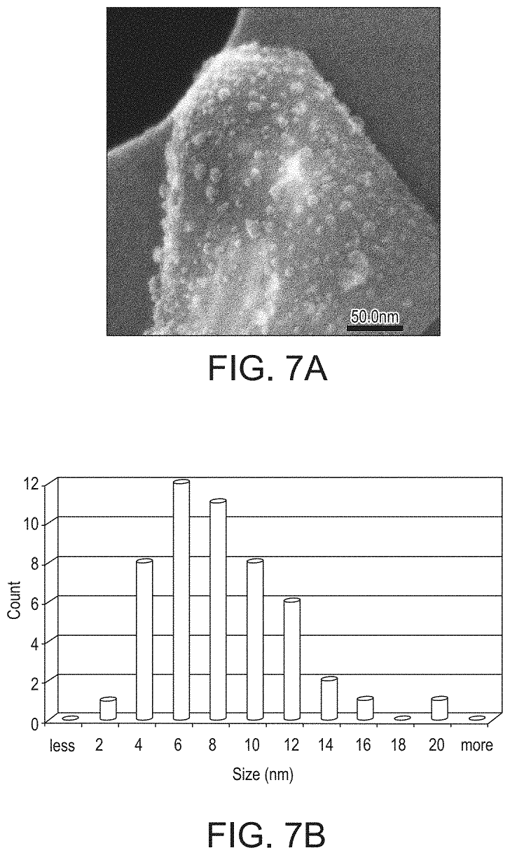

It has been found (see also the experimental section) that catalysts prepared in accordance with the present methods have improved properties. For example, the catalysts of the invention are less deactivated by SO₂ compared to catalysts prepared by other methods. Without wishing to be bound by theory, this is believed to be due to the rapid oxidation of SO₂ to SO₃ on the small metal-containing nanoparticles, and the lower adsorption capabilities of SO₃ compared to SO₂. These weakly adsorbed sulphur species are also removed more easily during regeneration. This is shown in e.g. FIG. 6b, in which nanoparticles prepared according to the invention (black line) show greater CH₄ conversion compared to nanoparticles prepared by other methods. The increase at about 110 mins shows regeneration, again to a higher % conversion than the comparative example. The high % conversion is maintained at the peak temperature of 550° C. By way of further example, catalysts of the invention also show good water tolerance properties. High performance is maintained, even after high temperature aging compared to catalysts prepared using other kinds of transition metal precursors. See e.g. FIG. 6a, in which materials of the invention maintain high CH₄ conversion for a substantially longer time than the comparative example, even when the temperature is lowered (see final portion of graph, from about 75 mins to 100 mins)

Method

In general, a first stage of the methods of the invention involves the provision of a suitable number of a certain class of metal ion-containing compounds, wherein the transition metal ions of these compounds combine to form transition metal-containing nanoparticles.

Metal Ion-Containing Compounds—General

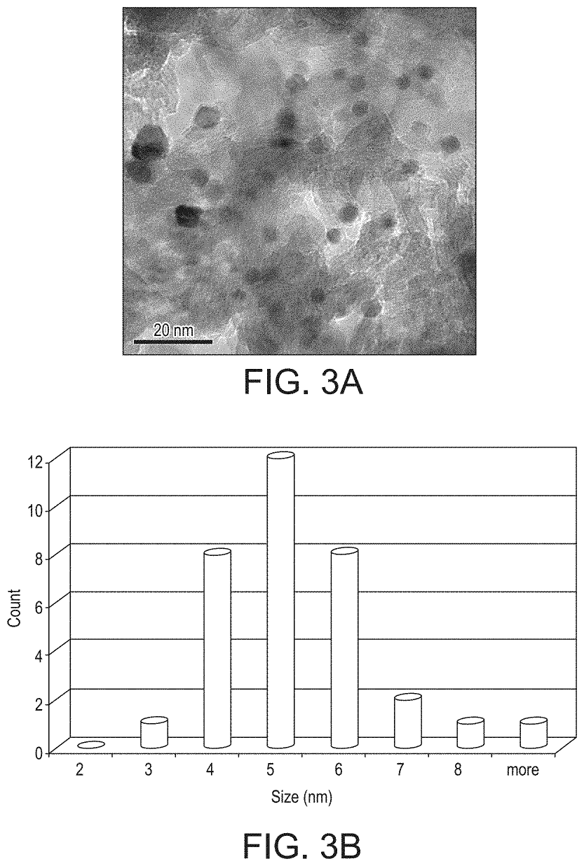

It is believed that metal-containing nanoparticles of particularly small particle size and homogeneous distribution can be produced from metal ion-containing compounds that can form stacks or chains in which the metal ions are aligned. These stacks or chains can be of variable length. Suitable metal-ion containing compounds are generally, though not exclusively, complexes having a d⁸ configuration. Suitable compounds generally adopt a square planar configuration. This is represented schematically in e.g. FIG. 2 using a glyoxime derivative by way of non-limiting example. This figure shows theoretically that the molecules can position themselves such that the metal ions M come comparatively close to one another and form a chain-like arrangement. Thus, when several kinds of metal ion are present as used in the present invention, it is believed that these kinds of molecules can form an intimate blend.

Complexes capable of forming such a “chain-like” arrangement have been described in the literature, see e.g. Day (Chimica Acta Reviews, 1969, 81), Thomas and Underhill (Chem. Soc. Rev. 1, 99 1972); Kamata et al. (Mol. Cryst. Liq. Cryst., 1995, 267, 117).

These references describe that two main kinds of compounds can form such arrangements. These are metal glyoximes, metal salicylaldimines and derivatives of each of these. These kinds of compounds are expected to be particularly suitable for use in the present invention. Each of these kinds of compounds can act as a bidentate ligand. The glyoxime-based ligands can coordinate to the central metal atom by two N atoms and the salicylaldimine-based ligands through one N and one O atom.

Without wishing to be bound by theory, it is believed that in the present invention the ability of these kinds of compounds to form chain-like arrangements with closely-positioned metal ions is important. Particularly, it is thought that when two kinds of metal ions are present, these kinds of compounds are capable of stacking such that the different kinds of metal ion are intimately mixed. See e.g. FIG. 2, in which M¹ represents a first kind of metal atom and M² represents a second kind of metal atom and M³ represents a third kind of metal atom. [R represents H or alternatively a derivative group, as discussed further below.] FIG. 2a represents a situation in which two kinds of metal ion are present i.e. it is expected that a bimetallic alloy or a mixture of two metals will result. FIG. 2b represents a situation in which three mutually different kinds of metal ion are present i.e. it is expected that a trimetallic alloy or mixture of three metals will result. Of course, alloys or mixtures should still result even if the alternation of the kind of metal ion is not a precisely homogeneous alternation as represented by FIG. 2. Thus, FIG. 2 is representative and not limiting herein and in practice some degree of randomization in the sequence of metal ions would not be unexpected. Further, it has been described (e.g. Day and Thomas referenced above) that in certain cases the glyoxime portion of the molecule can be rotated around the axis of the metal ion chain compared to adjacent molecules in solid state crystals. FIG. 2 is not intended to exclude such rotation.

A more detailed description of metal glyoximes, metal salicylaldimines and their respective derivatives follows now.

Metal Glyoximes and Derivatives Thereof

Metal glyoxime-based compounds comprise a metal atom and an appropriate number of glyoxime or glyoxime derivatives surrounding the metal atom. In the present invention, the metal is a transition metal, and there are (usually two) glyoxime or glyoxime derivatives surrounding the transition metal ion. Such compounds generally form a substantially square planar arrangement.

The present invention preferably employs metal glyoxime or metal glyoxime derivative as metal ion-containing compound, and most preferably a metal glyoxime derivative.

Glyoxime has the formula C₂H₄N₂O₂. It has the following structure (only one conformation is shown):

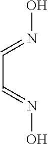

The two N atoms of each glyoxime molecule generally coordinate to the central metal ion in the resulting complexes.

A glyoxime derivative, as used herein, is glyoxime in which at least one hydrogen of the two C—H groups is substituted for an optionally substituted R group. Thus, a glyoxime derivative can be described by the formula (HO)N═C(R1)-C(R2)=N(OH).

In the present invention, each of R1 and R2 is independently H, hydroxy, alkoxy, carboxy or optionally substituted alkyl, aryl or heteroaryl group. Thus, where each of R1 and R2 is H, glyoxime results. Where one of R1 and R2 is not H, a glyoxime derivative results.

Preferably, R1=R2 i.e. preferably the glyoxime or derivative thereof is symmetrical. In some preferred embodiments, R1 and R2 are not both H.

Thus, a glyoxime derivative can have a —R′OH, —R′COOH or optionally substituted alkyl, optionally substituted aryl, or optionally substituted heteroaryl substituent in place of at least one, and preferably both, of the hydrogens attached to the carbon backbone of the glyoxime molecule. The expression “optionally substituted alkyl, aryl or heteroaryl” herein means that each of the alkyl aryl or heteroaryl groups can be optionally substituted. The group R′ represents a single bond or alkyl group as defined below.

Preferably, the glyoxime derivative has an optionally substituted alkyl, aryl or heteroaryl group.

Where R1 and/or R2 is an alkyl group, the alkyl can be linear, branched or cyclic. Cyclic alkyl encompasses the situation wherein R1 and/or R2 are independently cyclic alkyl groups, and wherein R1 and R2 join to each other to form a cyclic alkyl.

Linear or branched alkyl can be C₁₋₁₀ alkyl, preferably C₁₋₇ alkyl and more preferably C₁₋₃ alkyl. In certain preferred embodiments, R1 and/or R2 is C₁ alkyl (i.e. methyl).

Cyclic alkyl (also called cycloalkyl) can be C₃₋₁₀ cycloalkyl, preferably C₅₋₇ cycloalkyl, and more preferably C₆ cycloalkyl.

In the most preferred embodiments, R1=R2=C₁ alkyl.

Where R1 and/or R2 is aryl, this means aromatic hydrocarbon. Suitably, aryl means a C₆₋₉ aromatic group e.g. a phenyl or naphthyl group. Particularly preferred are phenyl (C₆) based aryl groups.

Where R1 and/or R2 is heteroaryl, this means aromatic hydrocarbon wherein one or more, preferably one, of the ring atoms is a nitrogen, oxygen or sulfur group. Preferably one of the ring atoms is nitrogen or oxygen, and particularly preferably it is oxygen. The heteroaryl group usually contains 5 to 7 ring atoms, including the heteroatom(s). Examples of suitable heteroaryl groups include pyridine, pyrazine, pyrrole, imidazole, pyrazole, oxazole, thiophene and furan. In preferred embodiments, the heteroaryl group is a furan. The heteroatom can be placed at any orientation, but is preferably in the alpha position.

The optional substituents of the R1/R2 groups are independently typically —R′OH, —R′COOH, or unsubstituted linear or branched C₁₋₁₀ alkyl, C₅₋₇ aryl or C₅₋₇ heteroaryl. R′ is as defined above. Preferably, the optional substituents are C₁₋₁₀ alkyl, and most preferably C₁₋₅ alkyl. Preferably, there is only one of the optional substituents present, if any.

Examples of suitable glyoxime derivatives in accordance with the above are: isopropylnioxime, 4-t-amylnioxime, nioxime, 4-methylnioxime, dimethylglyoxime, ethylmethylglyoxime, furil-α-dioxime, 3-methylnioxime, benzil-α-dioxime, heptoxime.

Particularly preferred in the methods described herein are metal dimethylglyoximes (metal-DMGs). Dimethyl glyoxime has the following structure:

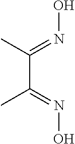

Typically, in accordance with the above, there are two DMG molecules surrounding each metal centre in a square planar configuration. For example, when Pt is the central ion and the glyoxime derivative is DMG, platin bis(dimethylglyoxime) is the metal glyoxime derivative precursor:

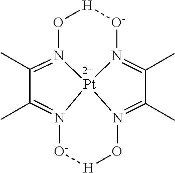

Different kinds of glyoxime or derivative can be used to provide the same metal. For example, a source of Pt may be Pt-DMG₂ and Pt-nioxime₂. Typically, only one kind of glyoxime or derivative thereof is used to provide a single kind of metal. Different kinds of glyoxime or derivative thereof can be present in the same complex, e.g. Pt-DMG-nioxime, though this is not typical.

In embodiments in which there are more than one metal ion-containing compound, and where more than one kind of metal ion-containing compound is a glyoxime or derivative thereof, it is not necessary that the glyoxime or derivative thereof be the same for each different kind of metal centre. For example, a Pt-containing compound may be Pt-DMG₂ while a Ni-containing compound may be Ni-nioxime₂. However, typically, only one kind of metal glyoxime or precursor thereof is provided for each kind of metal ion, e.g. Pt-DMG₂ and Ni-DMG₂.

Salicylaldimines and Derivatives Thereof

Salicylaldimine-based compounds comprise a metal atom and an appropriate number of salicylaldimine or salicylaldimine derivatives surrounding the metal atom. In the present invention, the metal is a transition metal, and there are two salicylaldimine or salicylaldimine derivatives surrounding the transition metal ion. Suitable compounds have a substantially square planar arrangement. It is noted that salicylaldimine containing complexes are sometimes known as salicylaldiminate or salicylaldiminato complexes.

Salicylaldimine has the formula C₇H₅NO. It has the following structure (only one conformation shown):

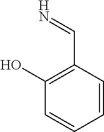

Each of the N and O atoms of each salicylaldimine molecule coordinates to the central metal ion in the resulting complex. The N atom is usually shown as being positively charged when coordinated to a metal centre.

A metal salicylaldimine derivative, as used herein, means a complex having two salicylaldimine derivatives coordinated to the central metal ion through their N and O atoms. A salicylaldimine derivative, as used herein, is salicylaldimine in which the hydrogen of the N—H group is substituted for an optionally substituted group R3 i.e. they are N-methyl derivatives. Thus, a salicylaldimine derivative can be described by the formula (R3)N═CH-Ph-OH where Ph represents phenyl and the OH group is located ortho to the (R3)N═CH group.

In the present invention, R3 is H, hydroxy, alkoxy, carboxy or optionally substituted alkyl, aryl or heteroaryl group. Thus, where R3 is H, salicylaldimine results. Where R3 is not H, a salicylaldimine derivative results.

Thus, a salicylaldimine derivative can have a —R′OH, —R′COOH or optionally substituted alkyl, aryl or heteroaryl group in place of the H attached to the N atom. The group R′ represents a single bond or alkyl group as defined below.

Where R3 is an alkyl group, the alkyl can be linear, branched or cyclic.

Linear or branched alkyl can be C₁₋₁₀ alkyl, preferably C₁₋₇ alkyl and more preferably C₁₋₃ alkyl. In certain embodiments, R3 is C₁ alkyl (i.e. methyl).

Cyclic alkyl (also called cycloalkyl) can be C₃₋₁₀ cycloalkyl, preferably C₅₋₇ cycloalkyl, and more preferably C₆ cycloalkyl.

Where R3 is aryl, this means aromatic hydrocarbon. Suitably, aryl means a C₆₋₉ aromatic group e.g. a phenyl or naphthyl group, preferably phenyl (C₆) based aryl group.

Where R3 is heteroaryl, this means aromatic hydrocarbon wherein one or more, preferably one, of the ring atoms is a nitrogen, oxygen or sulfur group. Preferably one of the ring atoms is nitrogen or oxygen, and particularly preferably it is oxygen. The heteroaryl group usually contains 5 to 7 ring atoms, including the heteroatom(s). Examples of suitable heteroaryl groups include pyridine, pyrazine, pyrrole, imidazole, pyrazole, oxazole, thiophene and furan. In preferred embodiments, the heteroaryl group is a furan. The heteroatom can be placed at any orientation, but is preferably in the alpha position.

The optional substituents of the R3 group are typically —R′OH, —R′COOH, or unsubstituted linear or branched C₁₋₁₀ alkyl, C₅₋₇ aryl or C₅₋₇ heteroaryl. R′ is as defined above. Preferably, the optional substituents are C₁₋₁₀ alkyl, and most preferably C₁₋₅ alkyl. Preferably, there is only one of the optional substituents present, if any.

Most preferably, in the salicylaldimine derivatives, R3 is unsubstituted alkyl or aryl, and most preferably unsubstituted alkyl. In the most preferred embodiments, R3 is C₁ alkyl.

A particularly suitable salicylaldimine derivative in accordance with the above is N-methylsalicylaldimine.

As with the glyoxime-based metal ion-containing compounds, different kinds of salicylaldimine or derivative can be used to provide the same metal. Typically, only one kind of salicylaldimine or derivative thereof is used to provide a single kind of metal.

As with the glyoxime-based metal ion-containing compounds, where more than one kind of metal ion-containing compound is a salicylaldimine or derivative thereof, it is not necessary that the salicylaldimine or derivative thereof be the same for each different kind of metal centre, or the same in a single complex. However, typically, only one kind of metal salicylaldimine or precursor thereof is provided for each kind of metal ion and in a single complex.

Also envisioned are embodiments in which at least one metal is provided by a metal salicylaldimine-based compound and at least one metal is provided by a metal glyoxime-based compound.

Metal Centres

Suitable metal centres are generally transition metal elements, so long as they can form the complexes explained herein. By “transition metal elements”, we mean those elements in Groups 3 to 12 of the periodic table, and includes the platinum group metals (PGMs). Typically, the metal ion containing compounds will include one or more metals selected from the group consisting of Pt, Pd, Mn, Fe, Ni, Ir, Ru, Rh, Co, Cu, Ag and Au. Preferably, the metal centres comprise those selected from the group consisting of Pt, Pd, Ni, Fe, Mn and Co, particularly preferably Pt, Pd and Ni.

Suitably, for the catalytic applications described herein, one of the metal centres of the metal ion providing compounds is Pd. Particularly preferred for the catalytic applications described herein are metal ion-containing compounds comprising Pd and/or Pt. For example, nanoparticles comprising Pt and Pd, e.g. in a weight ratio of 20:1 to 1:20, including 1:1, can be prepared by the methods of the present invention.

The metal ions of the metal glyoximes or salicylaldimines or derivatives thereof make up the metals in the nanoparticles described herein. Thus, if a single metal nanoparticle is wanted, metal ion-containing compounds having one kind of metal ion should be provided; if a bimetallic alloy is wanted, metal ion-containing compounds having two kinds of metal ion should be provided; if a trimetallic alloy is wanted, metal ion-containing compounds having three kinds of metal ion should be provided, and so on. If a single metal nanoparticle is wanted, metal ion-containing compounds having one kind of metal ion should be provided.

Provision of Metal Ion-Containing Compounds

The metal ion-containing compounds may be purchased directly. Alternatively, they may be synthesized from precursors using methods known to the skilled person.

By way of example for the glyoxime or derivative thereof, synthesis from precursors generally involves the combination of a glyoxime-based ligand such as dimethylglyoxime (DMG) with a metal salt and forming a solution, typically an aqueous solution. A precipitate of the metal glyoxime or derivative thereof results.

Typically, metal:ligand ratios of around 1:2 are used. The range may be between 1:10 to 1:2, such as 1:5 to 1:2. Higher proportions of metal are less preferred due to cost.

As an example, to prepare platin bis(dimethylglyoxime), an exemplary approach is as follows:

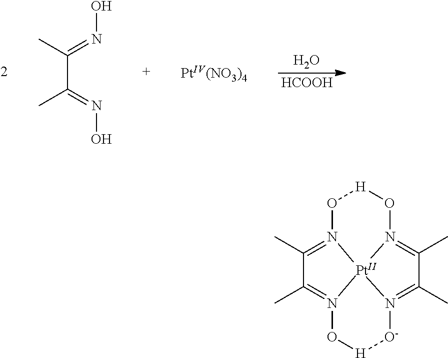

The metal glyoxime or derivative thereof that precipitates can be purified (i.e. separated from other components of the solution) in an appropriate manner e.g. by filtration and/or washing and/or drying. The skilled person will be aware of suitable purification steps.

In some preferred embodiments, the glyoxime-containing solution may be stirred and/or heated before and/or during precipitate formation. In some preferred embodiments, the heating follows the stirring.

Suitable stirring and/or heating periods will depend on the amounts and kinds of glyoxime-containing solutions, but may be for example up to 4 hours, up to 3 hours, up to 1 hour or up to 30 mins.

Suitable heating temperatures will be known to the skilled person, and may include for example up to 80° C., up to 60° C. or up to 40° C.

Suitable metal salts will be known to the skilled person, but non-limiting examples may include one or more selected from metal halides, metal nitrates, and metal acetates.

In some embodiments, the glyoxime-containing solution is acidified before it is stirred and/or heated. The skilled person can choose from among suitable acids, which may be weak or strong according to preference. Typically, the acid is organic. Non-limiting examples may include carboxylic acids such as formic acid or acetic acid.

In preferred embodiments, the composites of the invention are prepared by using a precipitation deposition method. Broadly, a suitable number of metal ion-containing compounds are dissolved in solution, which is usually basic, in the presence of a support. They are precipitated on the support with a suitable amount of acid. Without wishing to be bound by theory, it is thought that the rigid ligand framework of the compounds described herein contribute to stability of the complex (e.g. low lability) across a range of pH values. The precipitation has been found to be approximately quantitative i.e. most of the metal that is added as a complex is found to be precipitated. This method gives a good distribution of the nanoparticles across a support (where present), good catalyst activity and stability, and can be used with a wide range of supports.

Accordingly, preferably in the methods described herein, powders of the one or more metal ion-containing compounds can be added to a solvent to form a solution containing the dissolved metal ion-containing compound(s). Where more than one kind of metal ion-containing compound is used, they may be provided as separate solutions (and using different solvents if wanted), such that the separate solutions are later combined, or they may be dissolved together in a single solution. Suitable solvents include water (and aqueous solutions), and polar organic solvents. As examples of suitable polar organic solvents, mention is made of DMF and DMSO, though the invention is not limited thereto. Mixtures of suitable solvents may be used. Preferably, the solvent is aqueous. The formation of an aqueous solution can be advantageous from a safety and manufacturing perspective.

In some preferred embodiments, the metal ion-containing compound(s) (especially a metal glyoximes or derivatives thereof) may be dissolved to form aqueous solution(s) by adding a base. Suitably, the solution(s) containing the metal-ion containing compound(s) is alkaline. The pH is preferably more than 8, e.g. 9. Suitable bases will be known to the skilled person, but include for example ammonium derivatives such as ammonium hydroxide and tetraethylammonium hydroxide, or sodium hydroxide and potassium hydroxide.

In a general way, the solution(s) of the metal-ion containing compound(s) prepared as described above can be combined with a support. The support can be present in another, compatible, liquid if wanted. Thus, it can suitably be a suspension or dispersion in the liquid. This further liquid is thus preferably polar, most preferably aqueous. An aqueous or polar liquid is expected to assist in the dissolution of the metal ion-containing compound(s).

Typically, addition of the appropriate amount of metal ion-containing compound(s) to the support occurs dropwise, but may in certain instances be carried out as a single addition or as multiple additions. Combination of the metal ion containing compounds with the support can be carried out over a suitable period. Typically, a suitable period for addition of the metal ion-containing compound(s) to the support will be determined by the skilled person but conveniently will be up to an hour, such as 45 mins or 30 mins.

The metal ion-containing compound(s) are suitably mixed with the support prior to the heating step. Suitable methods will be known to the skilled person, but for example it is possible to combine an appropriate quantity of each desired metal ion-containing compound to form a mixture of metal ion-containing compounds, which is preferably a mixture of metal glyoximes or derivatives thereof, together with the support.

Following addition of the metal ion-containing compound(s) to the liquid, stirring typically occurs to thoroughly dissolve and combine the components and/or homogenize the dispersion. Stirring may take place for more than 1 hour, such as 4 or 8 hours or more. Conveniently, the mixture can be stirred overnight e.g. about 12 hours. Without wishing to be bound by theory, it is believed that this step allows intimate mixing and close approach of the metal ions. It may also assist in high dispersion of the metal-containing nanoclusters/nanoparticles across the support.

Various alternative routes of incorporating the support with the metal ion-containing compound(s) are envisioned, e.g. preparing the dissolved compound(s), mixing together if more than one compound is present, and then adding the support, or adding the dissolved compound(s)—either individually or simultaneously—to the support (also usually followed by further stirring). A preferred option is to provide the support in a liquid and add the metal ion-containing compound(s) to the support.

The combination of the support and one or more metal ion-containing compound(s) may be carried out with stirring. Once both the metal ion-containing compounds and the support are combined, the mixture is typically stirred thoroughly to combine as described above. It is preferred to use a support in the preparation methods described herein because they lead to supported nanoparticles which have improved properties for the present applications such as ease of handling and processing.

In general, the kind of support that can be used in the present invention is not particularly limited. Preferred are non-carbon-based support, such as oxides, zeolites and zeolite-based supports. Suitable oxides include aluminium oxides (alumina), cerium oxides, zirconium oxides, silicon oxides (silica) and titanium oxides (titania) or mixtures thereof. For example, preferred non-carbon-based support materials include one or more of Al₂O₃, Ce—ZrOₓ, SiO₂, and TiO₂. Most preferred are ceria and zeolite/zeolite-based supports.

The zeolite (or zeotype) supports encompass natural and synthetic zeolites. Also encompassed are silicate zeolites having a range of Al contents defined by the silica to alumina ratio (SAR). A preferred lower limit for the SAR is 5, preferably 8 and most preferably 10 for hydrothermal stability. The upper limit for the SAR may for example be 100, more preferably 40. Such materials may have ion exchange sites within the crystal structure. Examples of suitable zeolites for use in the present invention include chabaxite-based and Al-deficient zeolites and zeolite-based supports. The deficiencies in Al-deficient zeolites can be substituted with e.g. H or OH. Examples of suitable zeolite frameworks for use in the invention are MFI (e.g., ZSM-5) BEA, CHA (e.g. chabazite, SSZ-13, SAPO-34), AEI (e.g., SSZ-39), MOR (Mordenite) and FER (Ferrierite). It is believed that the metal ion-containing compounds are deposited on the surface(s) of the zeolite in nanoclusters. During preparation of the materials of the invention, it is thought that the metal is positioned at the ion-exchange sites.

Also encompassed are zeolite structures having little or no Al. In these cases, it is believed that the metal ion-containing compounds are deposited across the surface(s) of the zeolite in nanoclusters.

The support can be provided in any suitable form such as particulate, powder or needles. The invention is not particularly limited in this respect. Preferred are powders of the support. The powder may comprise particles of any desired size, such as microns or millimetres, and of any desired shape including but not limited to spherical or spheroid. The powder may be crystalline or amorphous according to requirements.

For certain applications, such as catalytic flow-through honeycombs or wall-flow filters used in the treatment of engine exhaust gas, the support is typically formed into a washcoat and thus will preferably have a particle size mean and range that facilitates desirable rheological properties of coatings—for example a particle size of about 0.1 to 25 microns and more preferably about 0.5 to 5 microns.

Other less preferred embodiments contemplate use of carbon-based supports such as graphite.

After stirring thoroughly to combine, the mixture of support and metal ion-containing compound(s) may preferably be neutralized (i.e. brought to pH 7) using any suitable acid. Suitable acids include organic and inorganic acids and mixtures thereof. Mention may be made of nitric acid, sulfuric acid and acetic acid but these are not limiting. The neutralization is optionally followed by further stirring. Again, conveniently, stirring may occur overnight e.g. around 12 hours.

The resulting mixture is typically dried at elevated temperature (e.g. at around 80° C. to around 110° C., to remove bulk solvent such as water but without burning off any of the components intended to be present in the final product). Drying is suitably carried out slowly, and conveniently overnight e.g. around 12 hours. Suitably, drying is carried out in air.

The result is a dried precursor mixture.

Heating Step

The heating step comprises heating the dried precursor mixture, containing the one or more combined metal ion-containing compounds, and the support. This step corresponds with the annealing step that provides the catalyst material from the composite material described elsewhere herein.

Suitably, the heating may take place in a furnace. Preferably, heating takes place in an oxidising atmosphere. The skilled person will be able to choose from suitable atmospheres. Suitable oxidising atmospheres contain for example air and/or oxygen.

An inert atmosphere is contemplated for other less-preferred embodiments, which may include for example one or more of hydrogen, argon and nitrogen, or a vacuum.

Accordingly, heating is suitably carried out at a temperature of up to 1200° C., up to 1000° C. or up to 900° C. In some embodiments, heating is carried out at a minimum temperature of 300° C., preferably at least 450° C. or 475° C. Preferably, the heating temperature is in the range of 450° C. to 700° C., suitably 450° C. to 600° C. such as around 500° C. The skilled person can determine a suitable heating temperature, particularly for alloys, because a useful temperature range may be connected to the nature of the metal(s) employed.

In general, higher temperatures may be preferred for preparing metal alloy nanoparticles. In such cases, the temperature is suitably at least 475° C.

Suitably, the heating temperature is reached by slowly increasing the temperature. For example, the heating rate may be up to 10° C./minute, up to 5° C./minute and preferably up to 2° C./minute such as about 1.5° C./minute. In this way, the temperature is increased slowly from room temperature over several hours. The duration of the heating step is not particularly limited.

For example, the duration of the heating step (including the time taken to reach the desired heating temperature, also called the final temperature herein) can be between about 1 to 15 hours, preferably between about 5 and 12 hours. For example, the heating step can be carried out for up to 15 hours, up to 14 hours or up to 13 hours. The heating step is preferably carried out for at least about 5 hours, such as 6 hours or 7 hours.

In other embodiments, so-called “flash” heating may have potential utility in achieving the desired temperature i.e. rapid heating carried out over a short period of time, such as over a matter of minutes. For example, the heating step can be carried out for up to 1 minute, such as up to 0.8 minutes or up to 0.5 minutes.

Once the final temperature is reached, the final temperature is suitably maintained for at least about 5 mins, such as 20 mins, and optionally longer. There is no particular limit on the time over which the final temperature can be maintained, but conveniently less than about 24 hours or less than about 12 hours is suitable. Typically, the final temperature is maintained for between about 0.5 and 8 hours, such as between about 0.5 and 3 hours.

Further Steps

After the heating step, the product is typically cooled, for example to room temperature. Suitably, cooling is carried out in the furnace in which heating is conducted.

Passivation may be carried out after the heating step, although this is not common for the applications described herein. Passivation typically occurs at room temperature. Therefore, passivation typically occurs after cooling. Typically, passivation occurs under a mixture of an inert gas and oxygen, such as air diluted with nitrogen. Conveniently, passivation can be carried out in the same furnace as heating was carried out. Passivation can advantageously prevent further reaction of the nanoparticles.

Optionally, the resulting metal-containing nanoparticles can be subjected to an acid leaching step. Suitable acids and timescales will be known to the skilled person. Purely by way of example and not limitation, the leaching step may occur over several hours such as up to 36 hours or up to 24 hours, and the acid used can be any common acid such as hydrochloric acid, sulfuric acid or nitric acid. Acid leaching can advantageously render the nanoparticles suitable for use in certain applications. Particularly contemplated is acid leaching for oxides of PtNi.

As noted elsewhere herein, the inventors believe that in certain embodiments a coating or overlayer comprising predominantly N and C and O can form over the surface of the metal alloy nanoparticles during annealing in an inert atmosphere. For certain applications, removal of this overlayer from the metal alloy nanoparticle surface may be desirable. Optionally, therefore, the metal alloy nanoparticles may be further treated to remove any such overlayer. Removal of such overlayer could be achieved by any suitable method; for example, use of an oxidant.

Preferences

Preferred embodiments of the invention concern composites and materials prepared from transition metal glyoxime derivatives as precursors to transition metal nanoparticles. In these preferred embodiments, the transition metal precursors are applied to an oxygen-containing support using a deposition and precipitation method. This method preferably involves dissolution of one or more metal glyoxime derivatives in an aqueous or polar solvent in the presence of a support, and acidifying, typically under stirring, to precipitate nanoclusters of the metal glyoxime derivatives across a support surface.

Preferably, the composite prepared using the precipitation and deposition method are subjected to heating at about 450 to 700° C. under oxidising conditions to partially, substantially or completely remove the glyoxime-based ligands and form metal-containing nanoparticles across the support surface.

The materials so prepared have been found to have a particularly small and uniform particle size and distribution across a support. Therefore, they are expected to show good functionality in the applications described herein and find particular utility in the treatment of exhaust gases.

### EXAMPLES

Examples of single metal and bimetal DMG precursors were prepared using reported methods, (J. Coord. Chem, 2008, 62 (15), 2429-2437; J. Phys. Chem. C 2014, 118, 24705-24713; Inorg. Chim. Acta, 1967, 161) with the difference that water was used as only solvent.

Examples were prepared by dissolving Pt-DMG and Pd-DMG with base and mixing with alumina. The corresponding amounts of Pd and Pt salts were suspended in 150 ml water and tetraethyl ammonium hydroxide was added dropwise until the salts dissolved. The support added while stirring, the stirring continued for 15 min. After this the pH of the slurry was adjusted with acetic acid until pH reached 5. The solid was filtered and washes with deionised water to remove the organics. The solid was dried and calcined at 500° C. for 2 h. The relative proportions of Pt and Pd are shown in the table below. Three different kinds of alumina-containing supports were used in Examples 1, 2 and 3.

Comparative examples were prepared according to prior art methods (incipient water impregnation: Chem. Rev., 1995, 95 (3), 477-510). The Comparative Examples used nitrate-based precursors and γ-Al₂O₃ as support.

Each was annealed at 500° C. in an air atmosphere.

The presence or absence of an alloy was confirmed using energy dispersive x-ray diffraction (EDX) with transmission electron microscopy (TEM), and in some instances x-ray diffraction (XRD).

The results are shown in Table 1. The methods of the present invention successfully prepare alloyed materials while the prior art protocols do not.

TABLE 1

| Example No./ | | | | |
|---|---|---|---|---|
| Comparative | Sample precursor/ | Pd:Pt | | Mean Particle Size |
| Example No. | preparation method | ratio (wt) | Result | (nm); Range (nm) |
| 1 | Pd-DMG + Pt-DMG/ | 0.82:1.77 | Alloy present | 4.7; 6.5 |
| | deposition precipitation | | | |
| 2 | Pd-DMG + Pt-DMG/ | 4.5:4.5 | Alloy present | 1.2; 2.3 [N.B. before |
| | deposition precipitation | | | firing] |
| 3 | Pd-DMG + Pt-DMG/ | 2.85:0.15 | Alloy present | 5.6; 14.7 |
| | deposition precipitation | | | |
| Comparative | Metal nitrates | 2.85:0.15 | No alloy | 3.5; 8.5 |
| Example 1 | | | present | |
| Comparative | Metal nitrates | 4.5:4.5 | No alloy | (data not available) |
| Example 2 | | | present | |

These results show that the present invention can be applied to a range of metal ratios and supports. It also shows that metal alloy nanoparticles can be prepared at lower temperatures compared to prior art methods. This advantageously lowers cost and reduces the resources needed to prepare the materials (more environmentally friendly).

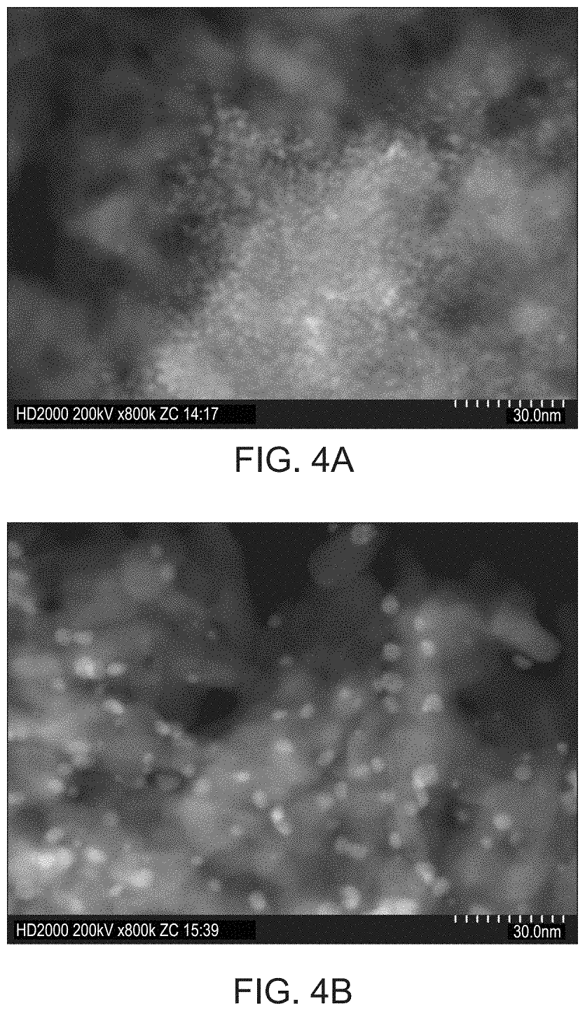

FIG. 3 shows a representative TEM image and particle size distribution of Example 1. The mean size is 4.7 nm (σ=1.3). In this example, the nanoparticles can be seen as spheroidal particles, which are dark in shape. These dark spheroids are separated by lighter areas. The nanoparticles are well-separated, have a good homogeneity and distribution across the support, and a similar size to one another.

### Example 4

Using a similar method to those used to prepare Examples 1-3, PtPd was prepared on γ-alumina in a 1:1 molar ratio at high metal loading (20 wt %) by preforming the binary salt on the support. Annealing was carried out at 500° C. in air. This sample was used to assess the effects of firing on the nanoclusters. The results are shown in FIG. 4.

FIG. 4a shows the composite sample i.e. before firing. Metal-containing nanoclusters can be observed as white spheroids. These are uniformly below 5 nm in size. The composition of the nanoclusters was also confirmed as containing both Pt and Pd atoms.

After annealing at 500° C. in air, an intermetallic phase was formed. The mean size increased slightly from 2.4 nm (before firing) to 4.3 nm (after firing) and the range increased slightly from 1.9 nm (before firing) to 5.5 nm (after firing).

### Example 5

The compositional make-up of Example 5 corresponds with that of Example 3. It was used to assess the effects of aging on the nanoparticles formed following annealing at 500° C. in air.

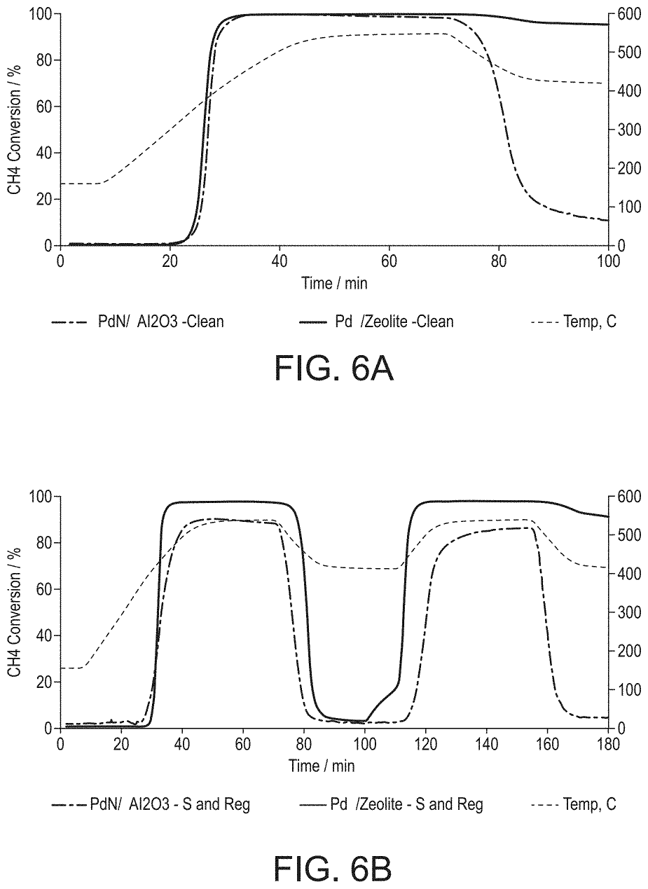

The results are shown in FIG. 5. Overall, very little aging effects were found. The mean particle size decreased slightly from 5.6 nm to 5.1 nm. The particle size range decreased from 14.7 nm to 9.0 nm. In FIG. 5, the light areas show the location of the nanoparticles, and they are separated by darker areas. It can be seen that the nanoparticles are spheroidal and relatively homogenous in shape, and are well-separated from one another and a relatively uniform distribution across the support surface.

It is considered that these results are promising for longevity of the catalytic materials of the present invention.

### Example 6

Pd nanoparticles on zeolite (ZSM-5) were prepared in a corresponding manner to Example 1 and tested for MeOx activity. The methane oxidation was tested initially under simple gas mix of methane and oxygen, and then in the presence of water, and then in the presence of SO₂.

As shown in FIG. 6a, this catalyst was found to have a high tolerance to water, particularly compared to the comparative catalyst prepared using metal nitrate.

As shown in FIG. 6b, although this catalyst was deactivated by 2 ppm SO₂ at temperatures close to 500° C., the activity was recoverable i.e. the catalyst showed good regeneration properties. This can be seen by the recovery of the conversion function in the second half of the graph, in which the SO₂ was turned off.

### Example 7 and Comparative Example 3

3 wt % Pd-DMG was dispersed in a corresponding manner to Example 1. The Pd salt (1.4 g) was suspended in 150 ml water and tetraethyl ammonium hydroxide was added dropwise until the salt dissolved. The support added while stirring, the stirring continued for 15 min After this the pH of the slurry was adjusted with acetic acid until pH reached 5. The solid was filtered and washes with deionised water to remove the organics. The solid was dried and calcined at 500° C. for 2 h. For the comparative example, 3 wt % Pd-nitrate was dispersed with ZSM-5. The Pd nitrate (7.7 g solution of 7.8 wt % Pd) was diluted to have total volume of 9 ml and the solution was to the support (19.7 g) and the mixture was homogenously mixed. The solid was dried and calcined at 500° C. for 2 h.

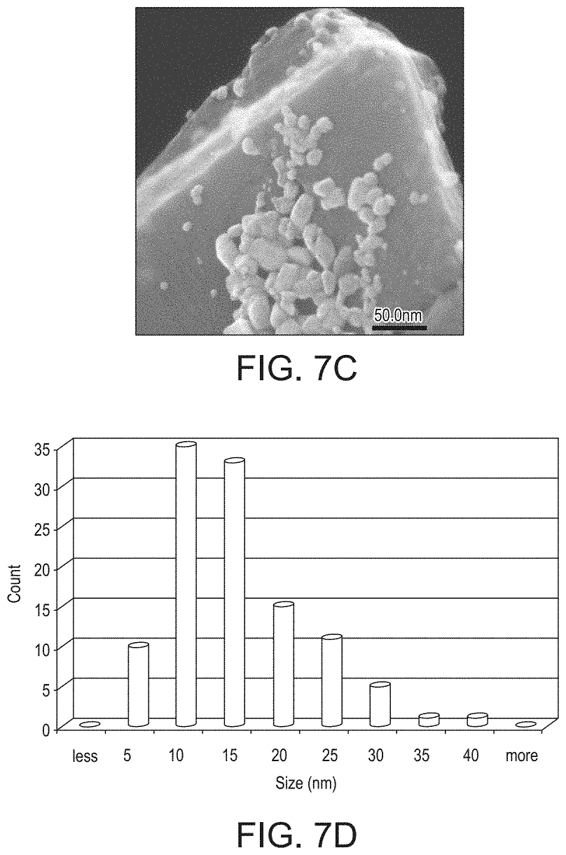

These were fired at 500° C. in air. The results are shown in FIG. 7.

The comparative example (FIG. 7c, 7d) shows nano-sized clusters roughly 10-15 nm in size (mean 12.6, σ 6.9). The Pd-DMG sample (FIG. 7a, 7b) shows substantially smaller nanoclusters of around 6-8 nm (mean 7.2, σ 3.6). These clusters are located on the surface of the zeolite, and are evident in FIG. 7a as spheroidal particles. The nanoparticles' shape in FIG. 7c are generally slightly less spheroidal than those of FIG. 7a, some particles appearing comparatively angular. A comparison of the two images also shows that the nanoclusters of Pd-DMG are more homogeneously distributed across the support surface than the Pd—N sample, whose particles show clear clustering.

### Example 8 and Comparative Example 4

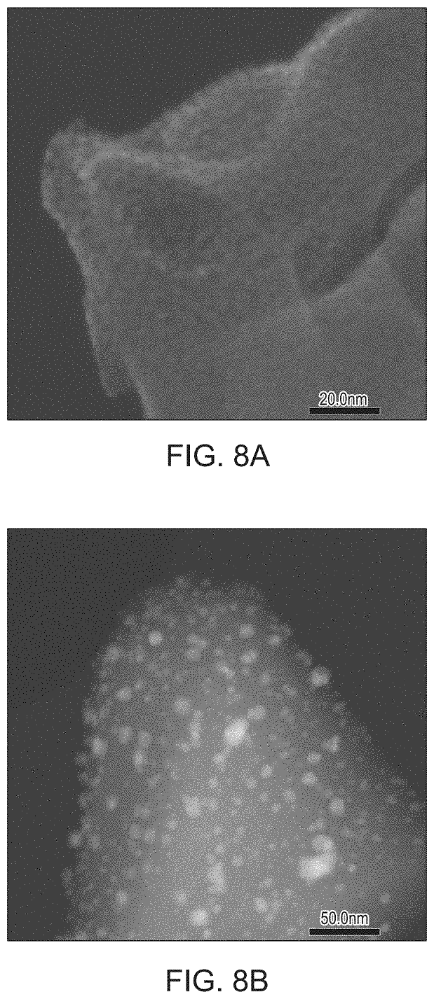

The effects of the firing procedure were investigated using 3 wt % Pd on a zeolite support using a deposition process. The results are shown in FIG. 8.

FIG. 8a shows that the nanoparticles produced using Pd-DMG before firing are small and homogeneously distributed over the support surface. The average nanocluster size was determined to be around 2 nm in size.

FIG. 8b shows that after firing in air at 500° C. for 2 hours, the metal nanoparticles formed are larger, around 5-7 nm. They remain homogeneously distributed and well-separated and recognisable as individual nanoparticles.

The nanoparticles can be seen as light areas, separated by darker grey areas. They are relatively uniform in size, show good homogeneity and distribution across the support surface, and are well-separated from one another.

### Example 9 and Comparative Example 5

The 3 wt % loading catalysts prepared from palladium nitrates (Pd—N) and Pd-DMG₂ as described above were tested for MeOx properties and especially their sulphur tolerance and regeneration characteristics. At 450° C. and 2 ppm SO₂, it was found that the catalysts using Pd-DMG₂ as starting material are less deactivated by SO₂ than the corresponding catalyst prepared from Pd—N.

In general, it was found that the catalyst of the invention was less deactivated by SO₂ with rapid regeneration at low temperature compared to the corresponding catalyst prepared with nitrate.

In addition, it was noted that the catalysts prepared by the methods described herein showed better sulphur tolerance and regeneration characteristics compared to corresponding Pd-DMG₂ catalysts prepared by physical mixing and wet impregnation methods.

Further experiments have showed that after high temperature aging, there is a drop in catalytic performance of the catalysts of the invention, though this is less pronounced than the drop after aging of catalysts prepared using Pd—N precursor.

Corresponding improvements are also seen for catalysts having an alumina support.

It will be appreciated by persons skilled in the art that the above embodiments have been described by way of example only, and not in any limitative sense, and that various alterations and modifications are possible without departure from the scope of the invention as defined by the appended claims.

### Example 10 and Comparative Example 6

1.5 wt % Pd-DMG₂ was dispersed on an AEI zeolite support in a corresponding manner to Example 1 and tested as PNA material. The Pd salt (0.47 g) was suspended in 150 ml water and tetraethyl ammonium hydroxide was added dropwise until the salt dissolved. The support added while stirring, the stirring continued for 15 min. After this the pH of the slurry was adjusted with acetic acid until pH reached 5. The solid was filtered and washes with deionised water to remove the organics. The solid was dried and calcined at 500° C. for 2 h and activated at 750° C. for 2 h. For the comparative example, 1.5 wt % Pd-nitrate on AEI was prepared as in comparative example 1 by incipient impregnation methods. The solid was dried and calcined at 500° C. for 2 h and activated at 750° C. for 2 h

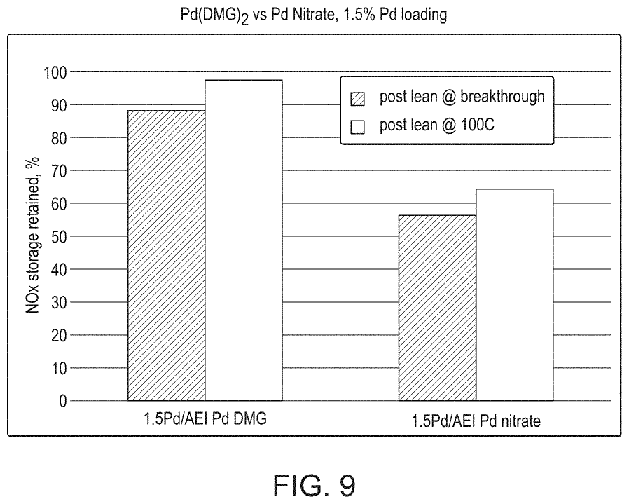

As shown in FIG. 9, the PdDMG₂ material was found to have a higher NOx storage performance at 100° C. (FIG. 9 left), particularly compared to the comparative catalyst prepared using metal nitrate (FIG. 9 right).

1. A composite comprising supported nanoclusters, the nanoclusters comprising one or more metal ion-containing compounds, wherein each metal ion-containing compound is a transition metal complex having ligands coordinated to a transition metal ion, the ligands being selected from the group consisting of glyoxime; a glyoxime derivative; salicylaldimine; and a salicylaldimine derivative; and wherein the nanoclusters are spaced across one or more surfaces of a support.

2. The composite according to claim 1, wherein the ligands are glyoxime or a derivative thereof, preferably having the formula (HO)N═C(R1)-C(R2)=N(OH), wherein R1 and R2 are each independently H, hydroxy, alkoxy, carboxy or optionally substituted alkyl, aryl or heteroaryl group, or R1 and R2 join together to form a cyclic alkyl.

3. The composite according to claim 1, wherein the support comprises at least one of aluminium oxide, cerium oxide, zirconium oxide, silicon oxide, titanium oxide, and a zeolite.

4. The composite according to claim 1, wherein the wherein the one or more metal ion-containing compounds of the nanoclusters comprise one or more transition metal ions chosen from the group consisting of Pt, Pd, Mn, Fe, Ni, Co, Ir, Ru, Rh, Cu, Ag and Au.

5. The composite according to claim 1, wherein at least one of the metal ion-containing compounds comprises a transition metal ion which is Pd, Ni, or Pt.

6. The composite according to claim 1, wherein the ligands are salicylaldimine or a derivative thereof, preferably having the formula (R3)N═CH-Ph-OH where Ph represents phenyl and the OH group is located ortho to the (R3)N═CH group, and R3 represents H, hydroxy, alkoxy, carboxy or optionally substituted alkyl, aryl or heteroaryl group.

7. The material formed from the composite of claim 1, in which the composite is subjected to a heating step to form metal-containing nanoparticles from the nanoclusters.

8. A catalyst comprising the material according to claim 7, optionally wherein the catalyst is selected from the group consisting of: a methane oxidation catalyst; a diesel oxidation catalyst; a compressed natural gas oxidation catalyst; a NOx reduction catalyst; an ammonia oxidation catalyst; and a gasoline three-way catalyst.

9. A passive NOx adsorber comprising the material according to claim 7.

10. A method of forming supported metal-containing nanoparticles or oxide thereof, the method comprising:
a. providing one or more transition metal ions by providing one or more metal ion-containing compounds and a support;
b. dissolving the one or more metal ion-containing compounds in a solvent;
c. a step of combining the support with the dissolved one or more metal ion-containing compounds;
d. a heating step in which the one or more metal ion-containing compounds are subjected to a temperature of at least 300° C. to form metal-containing nanoparticles or oxide thereof on the support;
e. a cooling step comprising cooling the product of step d; and optionally
f. a step of acid leaching;
wherein the one or more metal ion-containing compounds are transition metal complexes having ligands coordinated to a transition metal ion, the ligands being selected from the group consisting of glyoxime; a glyoxime derivative; salicylaldimine; and a salicylaldimine derivative.

11. The method according to claim 10, comprising providing one metal ion-containing compound to prepare nanoparticles of a single metal or oxide thereof, on the support.

12. The method according to claim 10, comprising providing more than one metal ion-containing compound to form nanoparticles of alloyed metals or oxide thereof, or a mixture of metals or oxide thereof, on the support.

13. The method according to claim 10, wherein the heating step is carried out in an oxidising atmosphere.

14. The method according to claim 13, which forms the material according to claim 7.

15. Metal-containing nanoparticles or oxide thereof, produced by the method of claim 10.

16. (canceled)

17. Use of a metal ion-containing compound which is a metal glyoxime, a metal glyoxime derivative, a metal salicylaldimine or a metal salicylaldimine derivative, in a method of forming metal-containing nanoparticles or oxide thereof, the method comprising dissolving the metal ion-containing compound in a solvent.

18. (canceled)

19. Use of the metal-containing nanoparticles or oxide thereof according to claim 15 as a catalyst or in a passive NOx adsorber.
